(19) United States
(12) Patent Application Publication
(10) Pub. No.: US 2014/0306982 A1
(43) Pub. Date: Oct. 16, 2014

(54) METHOD FOR SIMULATING HAIR HAVING VARIABLE COLORIMETRY AND DEVICE FOR IMPLEMENTING SAID METHOD

(71) Applicant: SPINNOVE, Paris (FR)

(72) Inventor: Pierre Ollivier, Paris (FR)

(73) Assignee: SPINNOVE, Paris (FR)

(21) Appl. No.: 14/352,878

(22) PCT Filed: Oct. 18, 2012
(86) PCT No.: PCT/EP2012/070689

§ 371 Date: Apr. 18, 2014

(30) Foreign Application Priority Data
Oct. 18, 2011 (FR) 1159396

(51) Int. Cl. G09G 5/02

(52) U.S. Cl. CPC G09G 5/026; G09G 2340/06; G09G 2340/12
USPC 345/589

(57) ABSTRACT

In a first aspect, the method for simulating hair having variable colorimetry comprises preliminarily recording, in a first database (101), a given number of images of given hairstyles and, for each image of a given hairstyle, at least one associated colorimetric conversion matrix for obtaining said hairstyle image by applying said matrix to a reference hairstyle image of the same style; preliminarily recording, in a second database (102), at least one colorimetric conversion matrix per lotion for a given number of capillary lotions (L₁-Lₖ); determining a resembling hairstyle image in said database by image recognition from an image of a hairstyle (401) retrieved from an initial digital image of a person (400); identifying, in the first database, a reference hairstyle image of the same style as the style of the resembling hairstyle image and a calorimetric conversion matrix associated with the resembling hairstyle image; creating an avatar (410) from the initial digital image of the person (400), which avatar superimposes the image of the face of the person (402) preliminarily retrieved from said initial image, and a hairstyle image (403) reconstructed by applying a calorimetric conversion matrix associated with the resembling hairstyle image to an image of a reference hairstyle from said first database; applying a calorimetric conversion matrix from said second database (102), which matrix corresponds to the capillary lotion selected for simulating the expected color, to said reconstructed hairstyle image.

### TECHNICAL FIELD OF THE INVENTION

The present invention relates to a method for simulating hair using variable colorimetry and to a device for implementing said method.

### PRIOR ART

Simulation methods are known today that offer a person self-visualization with a new hairstyle before the hairstylist effectively cuts and/or colors the hair.

The patent application EP 2 124 185 thus describes a method allowing fine detection of the contour of a hairstyle in order to offer a person a simulation of his face with a different hairstyle.

The application WO 9821695 describes a hairstyle simulation method in which a hairstyle type can be chosen from a database by a person, and then geometric transformations are applied to the chosen hairstyle type in order to obtain a hairstyle that is able to be superimposed plausibly on an initial photograph of the person. Using this method, it is likewise possible to modify the color of the hairstyle in order to make it compliant with the color of the initial hairstyle of the person, allowing plausibility to be further increased.

The present application describes a method for simulating hair using variable colorimetry that allows the new color that the hair of a person will have after application of a lotion of his choice, according to his present or future hairstyle type, to be simulated, in real time, in detail and at reasonable technical cost at a consumer point of sale.

### SUMMARY OF THE INVENTION

According to one aspect of the invention, the invention relates to a method for simulating hair using variable colorimetry comprising:
the prior recording, in a first database, of a given number of hairstyle images in given types, and, for each hairstyle image in a given type, of at least one associated calorimetric conversion matrix allowing said hairstyle image to be obtained by applying said matrix to a reference hairstyle image in the same type;
the prior recording, in a second database, for a given number of hair lotions (L₁-L_{K}), of at least one colorimetric conversion matrix per lotion;
the determination, by image recognition on the basis of an image of a hairstyle extracted from an initial digital image of a person, of a lifelike hairstyle image in said database,
the identification, in the first database, of a reference hairstyle image in the same type as that of the lifelike hairstyle image and of a colorimetric conversion matrix associated with the lifelike hairstyle image,
the creation, on the basis of the initial digital image of the person, of an avatar superimposing, on the image of the face of the person previously extracted from said initial image, a hairstyle image reconstructed by applying to a reference hairstyle image from said first database a colorimetric conversion matrix associated with the lifelike hairstyle image;
the application, to said reconstructed hairstyle image, of a colorimetric conversion matrix from said second database corresponding to the hair lotion chosen in order to simulate the expected color.

From the prior creation of a database comprising colorimetric conversion matrices associated with various hairstyle images of varying hairstyle type and hair type, it is possible to create an avatar that superimposes a realistic reconstructed hairstyle image on the face of the person wanting to simulate a change of hairstyle, a reference hairstyle image and a colorimetric conversion matrix being associated with the reconstructed hairstyle image. It is thus possible to apply to the reconstructed hairstyle image the transformation associated with a hair lotion of his choice, making it possible to implement a real time simulation at the point of sale.

According to one variant, each hairstyle exhibits a given hairstyle type and hair type, and, for each hairstyle image, said associated colorimetric conversion matrix allows the conversion of the colorimetric value of each pixel of said hairstyle image in relation to the colorimetric value of the corresponding pixel of a reference hairstyle image in the same hairstyle type.

Advantageously, said conversion matrix is a square matrix and the colorimetric value of a pixel its component according to the colors red, green and blue (RGB component).

According to one variant, the colorimetric conversion matrix per lotion allows the conversion of the colorimetric value of each pixel of a reference hairstyle image with the colorimetric value of each pixel of the same reference hairstyle image after application of said lotion to given hair of the hair type from which the reference hairstyle comes.

The step of creating the avatar may be automatic or semiautomatic. According to one variant, the reconstructed hairstyle image is obtained by applying the conversion matrix associated with the lifelike hairstyle image to a reference hairstyle image from the database in the same type as the lifelike hairstyle image. The reconstructed hairstyle image is thus faithful in terms of type and color to the hairstyle image of the person. According to another variant, the reconstructed hairstyle image is obtained by applying the conversion matrix associated with the lifelike hairstyle image to a reference hairstyle image from said database in a different type than that of said lifelike hairstyle image. This variant can be implemented when the person wishes to visualize himself with a hairstyle of different type, for example.

According to one variant, the method according to the first aspect moreover comprises, for a given reference hairstyle, the prior recording, in said first database, of a given number of reference hairstyle images according to various shot parameters and the recording of one or more conversion matrices, each linked to one of said parameters and allowing conversion of the colorimetric values of each of the pixels of a reference image associated with said parameter on the basis of those of each of the pixels of a reference image defined as principal reference image.

It is thus possible to take account of the shot parameters of the image capture for the person at the point of sale and to possibly correct shot parameters of the reference images.

According to one variant, the method according to the first aspect moreover comprises, at the time of the prior recording of said first database and/or of said second database, a step of simplification of the colorimetric conversion matrices comprising the definition of colorimetric conversion matrices by zones of the image. This simplification step allows the finesse of the simulation to be suited to the calculation capabilities available at the point of sale and thus allows the best compromise to be found over the quality of the simulation.

According to one variant, the colorimetric conversion matrices of said hairstyle images each form part of a set of metadata associated with each of said hairstyle images. Advantageously, the metadata, multi-format, will moreover be able to comprise attributes of the hairstyle image, including shot parameters, for example. The recording in the form of metadata allows the size of the databases to be reduced.

According to a second aspect of the invention, the invention relates to a device for simulating hair using variable colorimetry comprising:
storage means comprising:
   a first database with a given number of hairstyle images in given types, and, for each hairstyle image in a given type, at least one associated colorimetric conversion matrix allowing said hairstyle image to be obtained by applying said matrix to a reference hairstyle image in the same type;
   a second database with, for a given number of hair lotions, at least one colorimetric conversion matrix per lotion;
means for acquiring an initial digital image of a person;
a calculation unit allowing:
   the determination, by image recognition on the basis of an image of a hairstyle (401) extracted from an initial digital image of the person (400), of a lifelike hairstyle image in the first database,
   the identification, in the first database, of a reference hairstyle image in the same type as that of the lifelike hairstyle image and of a colorimetric conversion matrix associated with the lifelike hairstyle image,
   the creation of an avatar for said person, superimposing, on the image of the face of the person previously extracted from said initial image, a hairstyle image reconstructed by applying to a reference hairstyle image from said first database a colorimetric conversion matrix associated with the lifelike hairstyle image, and
   the transformation of said reconstructed image by applying a colorimetric conversion matrix from said second database corresponding to the hair lotion chosen for simulating the expected color.

According to one variant, said storage means are arranged in a server situated at a distance from the calculation unit, and moreover comprising a remote connection between said server and the calculation unit. Thus, it is not necessary to have the storage means at the point of sale and, in the event of a plurality of points of sale, the databases can be updated in a centralized manner for all of the points of sale.

### BRIEF DESCRIPTION OF THE DRAWINGS

Other advantages and features of the invention will emerge upon reading the description, which is illustrated by the following figures:

FIG. 1, an overview diagram describing the step of setup of a database of hair and the colorimetric variants thereof; according to one exemplary embodiment;

FIG. 2, an overview diagram describing the step of setup of a database of lotions and of the effects thereof on the hair, according to one exemplary embodiment;

FIG. 3, an overview diagram describing an exemplary embodiment of a method for simplifying the colorimetric conversion and/or transformation matrices, for the purpose of setting up the database of the colorimetric metadata of the reference hairstyles and the database of the colorimetric metadata of the hair lotions;

FIG. 4, an overview diagram describing the step of simulation of the hair of a person and the creation of personal colorimetric metadata, according to one exemplary embodiment;

FIG. 5, an overview diagram describing the step of simulation of the effect of a lotion on the hair of a person, according to one exemplary embodiment;

FIG. 6, a diagram describing an exemplary embodiment of a device for the implementation of the method according to the invention.

### DETAILED DESCRIPTION

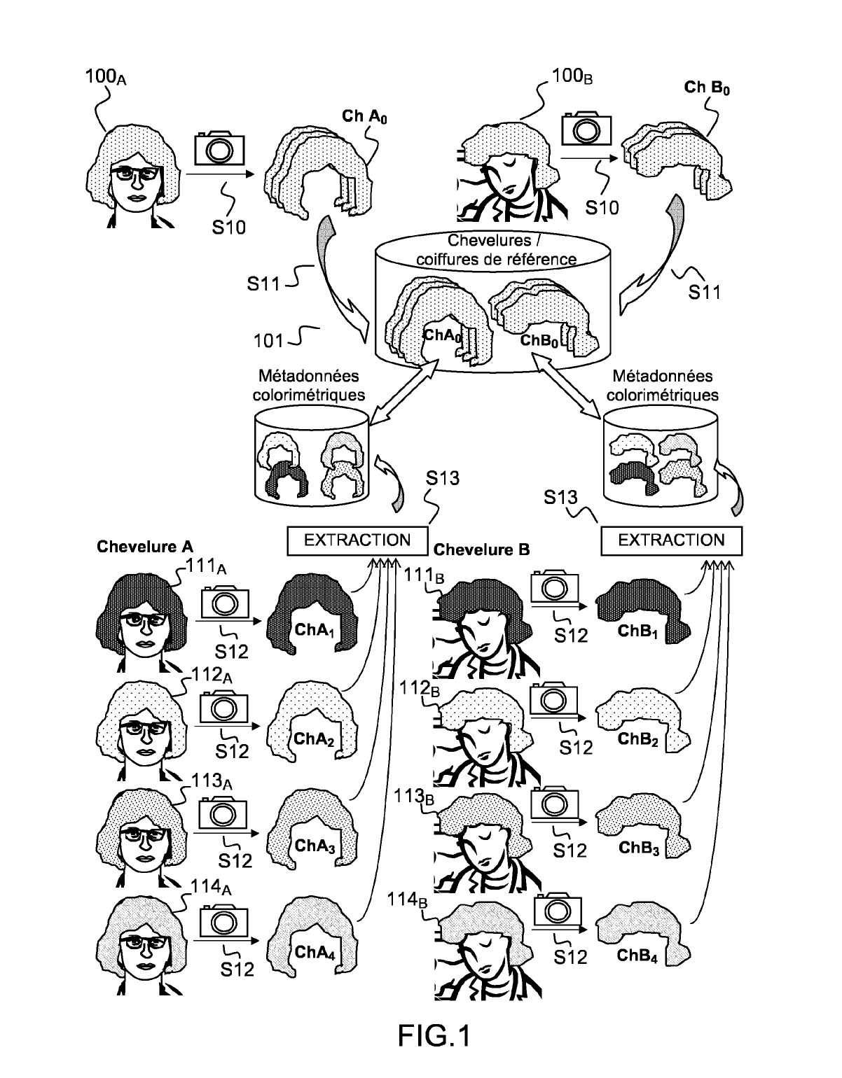

FIGS. 1 to 5 describe the various steps of the implementation of the method according to the invention according to an exemplary embodiment.

FIG. 1 illustrates a first step comprising the creation of a first database 101, associating colorimetric conversion matrices with a given number of hairstyle types and hair colors. It thus involves prior implementation of mapping for a large number of hairstyle types and hair colors. This prior step of creation of the first database is carried out in a specialized laboratory, for example.

In a first step S10, high-resolution digital images of various hairstyle types (A, B) belonging to various persons (100_{A}, 100_{B}) are acquired. Hairstyle type is generally understood to mean the arrangement of the hair (loose hair, short hair, hair with bangs, hair put up in a bun, plaited hair, etc.) and possibly its texture (stiffness, suppleness, shine, curls, etc.). Each image constitutes a reference image for the hairstyle type. These images are taken for a given color of the hair, for example a light color, for example a blonde type, which will constitute the reference color. According to one variant, the reference images of the various hairstyle types are taken under normalized shot conditions, these conditions being notably lighting, shot distance, shot angle, etc. According to another variant, for a given hairstyle type, several images will be able to be taken under various shot conditions. It will thus be possible to define a principal reference image for the hairstyle type among these reference images.

In a step S11, a set of data comprising, besides the colorimetric value of each pixel of the image, parameters linked to the shot conditions and descriptive parameters for the image (for example the resolution thereof) is extracted from these images, all of these data forming attributes of the image that are recorded in the form of metadata associated with each image, these metadata being able to be in multimedia form. For example, the metadata may comprise texts, images, texture forms, photographs, etc.

In the event of several reference images being taken under various shot conditions for a given hairstyle type, the metadata of the various reference images will moreover be able to comprise one or more conversion matrices linked to each of the shot parameters, and allowing conversion of the colorimetric values of each of the pixels of the reference image on the basis of those of each of the pixels of the image defined as principal reference image. Thus, by way of example, in the example from FIG. 1, the images ChA₀ form a set of reference images taken with various shot conditions for the person 100_{A} having the hairstyle type A, and the images ChB₀ form a set of reference images taken with various shot conditions for the person 100_{E} having the hairstyle type B. Among these images, an image will be defined for each hairstyle type, A or B, which will form a principal reference image for the hairstyle type under consideration. This step will be able to be reproduced for a number N of hairstyle types.

In a step S12, high-resolution digital images of persons 111_{A}, 112_{A}, 113_{A}, 114_{A} etc. having a hairstyle in a given hairstyle type, for example A, with hair of different type, for example, various natural colors, are produced. This step is reproduced for each of the hairstyle types. For each hairstyle type, it will be possible to record M images that each correspond to a color, for example, of the order of ten or so or one hundred or so natural colors according to the desired objective in the exemplary embodiment in question, which are respectively indicated ChA₁, ChA₂, etc. for the hairstyle type A and ChB₁, ChB₂, etc. for the hairstyle type B in FIG. 1. According to one variant, a high-resolution digital image of a person having a given hairstyle type and a given hair type can be acquired, and then images of the same hairstyle type but various hair types can be calculated on the basis of the acquired image in order to put together the images 111_{A}-114_{A}.

A step S13 then allows, for each given hairstyle type and each given natural color, extraction of a colorimetric conversion matrix corresponding to a given natural color. The conversion matrix allows the conversion of the colorimetric value of each pixel of the image of the hairstyle (for example ChA₁) on the basis of the colorimetric value of the corresponding pixel of the image of the reference hairstyle of the same hairstyle type (or principal reference hairstyle), for example ChA₀. It is possible, in some cases, for geometric transformation to be necessary between two hairstyle images of the same type, the images being acquired from two different persons. In this case, the correspondence of the pixels from one image to the other is understood following application of said geometric transformation. Thus, each image also has associated metadata that may comprise, besides the colorimetric value of each pixel of the image, the colorimetric conversion matrix and possibly parameters linked to the shot conditions and descriptive parameters of the image.

At the conclusion of this step, a first database 101 is obtained that stores a set of metadata that are each associated with a hairstyle image and notably comprise the associated colorimetric conversion matrix/matrices.

Advantageously, it is possible to simplify the colorimetric conversion matrices associated with the hair types and/or the conversion matrices corresponding to the various shot parameters, specifically with the aim of subsequently simplifying the calculations for simulating the hair of a person, as will be described later. It is thus possible to reconstruct all the colorimetric variants of a hairstyle/of hair solely on the basis of its reference image, and by applying a model for recomposing the lights, colors and geometries of the shots across the colorimetric conversion matrices.

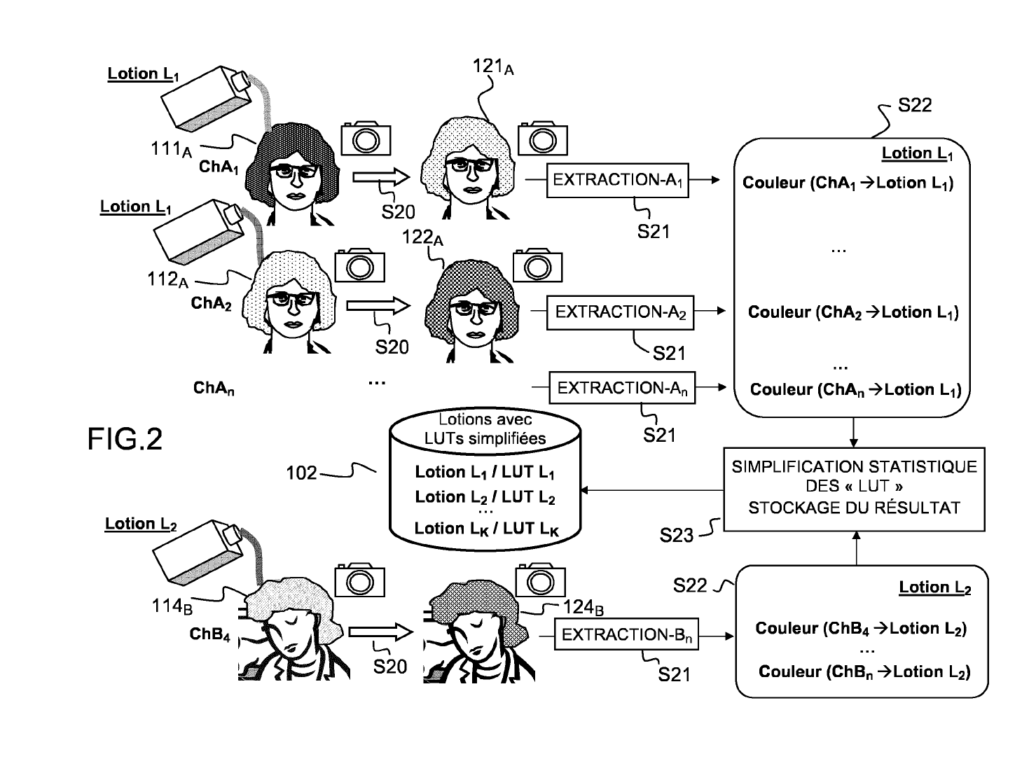

Advantageously, the database will be able to be enriched as a function of time with new images corresponding to associated new hairstyle types and/or natural colors, with, each time, an update of the metadata associated with the various images, and notably an update of the colorimetric conversion matrices. FIG. 2 illustrates a second step involving the creation of a second database 102 that associates at least one colorimetric conversion matrix per hair lotion with a given number of hair lotions. The colorimetric conversion matrix of a lotion allows, by way of example, conversion of the colorimetric value of each pixel of a reference hairstyle with the colorimetric value of each pixel of the same hairstyle following application of said hair lotion to a hair type on the basis of which the reference hairstyle is obtained.

In a first step S20, various hair lotions are applied to various persons having varied hairstyle types and natural colors and high-resolution digital images of the hairstyles are acquired following application of the lotion. By way of example, in the example in FIG. 2, a hair lotion L₁ is applied to the various persons 111_{A}, 112_{A}, etc. having the hairstyle type A and the hair types ChA₁, ChA₂, respectively, and a lotion L₂ is applied to the person 114_{E} having the hairstyle type B with the hair type ChB₄. High-resolution images are taken of the hairstyles once the lotion has been applied to the hair and the hairstyle has been re-done according to the initial type (121_{A}, 122_{A} for the application of the lotion L₁ to the hair ChA₁ and ChA₂ and 124_{B} for the application of the lotion L₂ to the hair ChB₄). Alternatively, by simplifying the process, it is also possible to limit the application of the lotion to a small quantity of reference types for one and the same given hair (and thus of a given hair type with a given natural color), or even a single type, when it is estimated with a sufficient degree of confidence that the results obtained by the application of the lotion to each of the various hairstyle types produced on the basis of this same hair will ultimately result in equivalent colorimetric conversion among types.

In a step S21, for each image resulting from the application of the lotion, metadata associated with the images are extracted and then colorimetric conversion matrices are calculated and recorded (step S22) per lotion that allow the conversion of the colorimetric value of each pixel of the image of the hairstyle following application of the lotion (for example 121_{A}) on the basis of the colorimetric value of the corresponding pixel of the reference hairstyle in the same hairstyle type (or principal reference hairstyle), for example ChA). This calculation and recording step can be carried out for various hair lotions applied to various hairstyle types using a method equivalent to that described in step S20 above, as shown in FIG. 2.

Advantageously, it is possible, during a step S23, to apply a statistical simplification of the transformation matrices obtained, allowing definition, for each hair lotion, of a single simplified transformation matrix, or a limited number of transformation matrices. By way of example, it will be possible to state that the transformation matrix associated with a given hair lotion is similar to a set of hairstyle types and/or a set of hair colors, allowing limitation, per lotion, of the number of transformation matrices.

The second database 102 recording the associated colorimetric conversion matrix/matrices for each hair lotion is then obtained.

Advantageously, in the step of extracting the colorimetric conversion matrices associated with the hair types (S13) and/or in the step of extracting the colorimetric conversion matrices applied to the hair lotions (S22), simplifications will be able to be provided for the various matrices. Strictly speaking, the colorimetric conversion matrices are square matrices that are also called “look up tables” or LUT, making it possible to provide the RGB (“red green blue”) component of each pixel of the final image on the basis of the RGB component of the corresponding pixel of the reference image. Each pixel therefore has an associated colorimetric conversion matrix. The simplifications aim to simplify the matrices by defining zones of the image, or masks, in which the colorimetric features of the image are sufficiently homogeneous to be able to define identical colorimetric conversion matrices for all of the pixels of the zone. The simplifications likewise aim to simplify the conversion matrices by defining zones that are sufficiently homogeneous to be able to define diagonal conversion matrices, or matrices that are simplified in relation to the initial matrices. The masks defined in this manner are part of the attributes of the image and the metadata associated with the images will be able to include successions of pairs (zone/LUT) that will be able to be recorded in the databases.

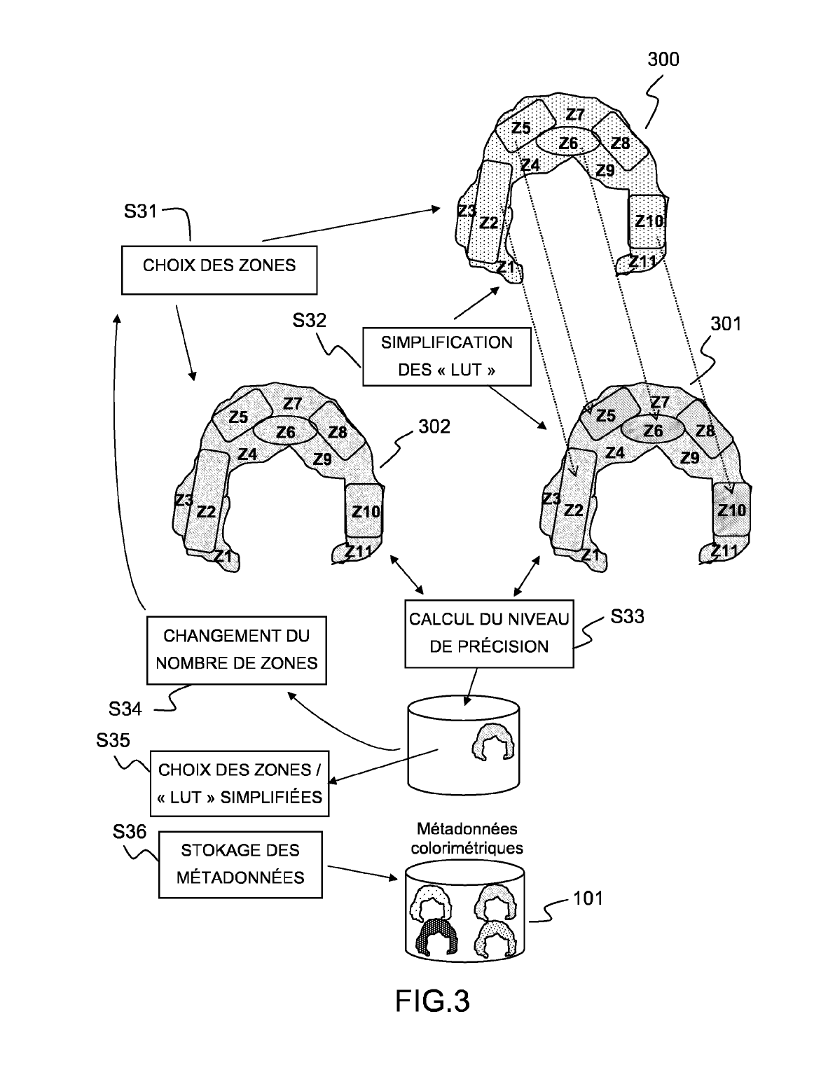

FIG. 3 illustrates, in a particular embodiment of the invention, a method for simplifying the LUTs between an initial reference image and a target image 300 whose conversion matrix is recorded in the database. In this embodiment, a first step S31 involves selecting a given number of zones Zi that are considered homogeneous on the target image 300, this number firstly needing to be as small as possible in order to facilitate the subsequent processing of the image but as large as possible (that is to say with very small zones, the extreme being one zone per pixel) if the aim is for each simplified matrix obtained to be as close as possible to the real pixel-by-pixel transformation matrix. There is therefore optimization to be found in the simplification that will be a function of the final processing cost sought at the point of sale. This optimization can be obtained by iteratively repeating the process described below. Each iteration involves selecting a number N of zones, which are not necessarily separate, calculating (step S32) the simplified LUTs for each zone then calculating (step S33) a function called “level of precision” for the whole image. This function involves calculating the difference between the image 301 obtained by applying the simplified LUTs for all the zones to the initial reference image, on the one hand, and, on the other hand, the image 302 obtained from the initial unsimplified pixel-by-pixel transformation LUT for the initial reference image.

The procedures for choosing and selecting a certain number of zones (step S31) may be very diverse. Consequently, the image editing professionals currently use zone definition tools, either using geometric contour selection means or using methods linked to color histograms; they then produce the transformations that they desire on these zones. By way of example, the patent application WO98/21695 cited previously uses a method for selecting zones by means of histograms.

Within one and the same chosen zone, the simplification of the LUT involves firstly making linearity assumptions in the logarithmic color space in one dimension (that is to say that is independent of RGB color channels) in order to apply a calculation that is very commonly performed in editing tools, of the type Rout=(GAIN*Rin+LIFT)^{GAMMA}, where the indicated parameters have the following meanings: LIFT for adjusting dark colors, GAIN for adjusting light colors and GAMMA for adjusting intermediate tones. The parameters LIFT, GAIN, GAMMA of said linearity are calculated per ROB color channel by using a statistical method of least cost of scatter (for example variance). Alternatively, it is also possible to provide even finer simplification by going to look, still in the chosen zone, for the matrix parameters that bring in the influence of neighboring channels (“cross talks”) in order better to take account of the second order effects between channels that the linearity will not be able to provide. This may prove to be of particular benefit if there are large shade contrasts on certain hairstyles, the eye being sensitive to the effects of relative color induced between visually close zones and of substantially different colors.

Secondly, once the zones have been selected and the simplified LUTs obtained, a statistical measurement calculation of the dispersion over the whole of the image between reality and the result from the simplified LUTs is performed (step S33). The result of this calculation is called the “level of precision” of this first selection of zones.

The process above is then repeated (step S34) by selecting a different number of zones (either smaller or larger) and by comparing the levels of precision found at the end of the process. Thus, by virtue of successive iterations, the operator will end up by finding (step S35) the features best suited to the hairstyle type for which the simplification has been made and to the model of use at the point of sale with the corresponding required level of precision. It is these features (associated zones Zi/conversion matrices set) that will then be recorded in the database of colorimetric metadata 101 that the aim is to set up (step S36).

A similar simplification process can be applied to the conversion matrices for creating the colorimetric metadata associated with the hair lotions in the second database 102.

For simplifying the conversion and/or transformation matrices, variants of the process that is described above are possible.

By way of example, an editing professional can work on the image of the reference hairstyle in successive operations using the tool he has available (for example Photoshop®), with the aim of using these operations to get as close as possible to the target image of the hairstyle to be reproduced by means of colorimetric transformations on the image of the reference hairstyle. The operations with all the features thereof, notably the chosen zones and the associated LIFT, GAIN, GAMMA coefficients, are then put on a list of metadata, a list (“color decision list”) describing a series of the colorimetric metadata that is then exported to the database associated with the target image. The level of precision obtained by the manual operations thus performed by the professional is likewise calculated.

According to another example, mathematical tools for mass classification of data are used, such as those used for evaluations of credit risks or financial markets, in order to perform all of the operations above, including the successive reiterations part, more or less automatically. The zones are then chosen on the basis of a geometric or calorimetric algorithm systematically and according to certain criteria, for example criteria of geometric shapes with an increasing surface area or criteria of choice of histograms for shades of gray (cf. patent application WO98/21695 cited previously). Furthermore, a classification algorithm uses the “level of precision” criterion and/or any other criterion deemed relevant, for example, the number of electronic operations necessary for processing at the point of sale. This allows identification of the best compromise between number of zones and sought-after precision and subsequent recording thereof in the database.

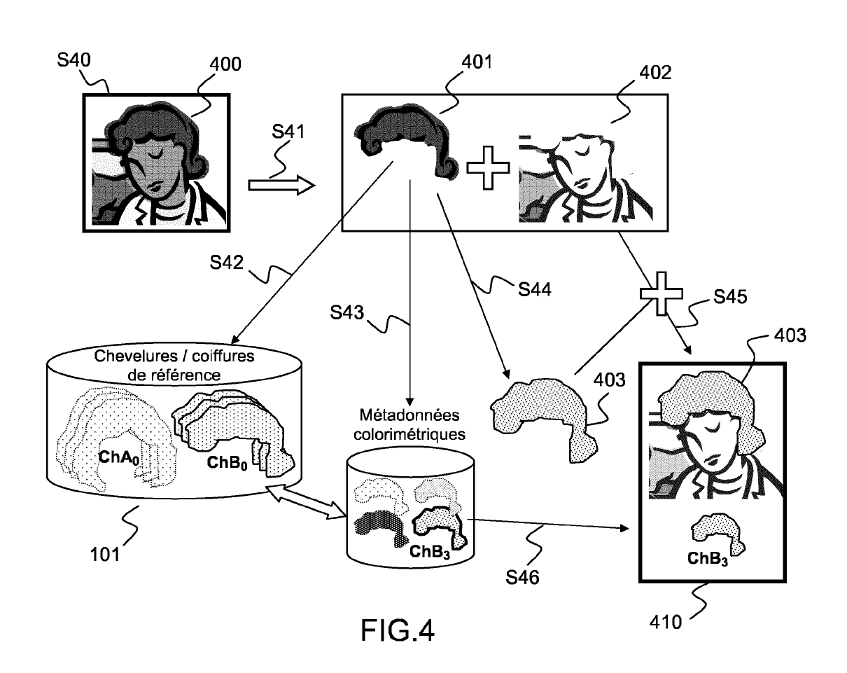

FIG. 4 illustrates a third step of the method according to the invention, this time implemented directly at the location where it is necessary to provide the simulation of the calorimetry for the hair of a person 400, called “point of sale” in the rest of the description, and involving the creation of an avatar 410 for the person by means of the data recorded in the first database 101.

In a first step S40, a digital image 400 of the person is acquired. This image can be recorded using lightweight technical means, which are accessible at the point of sale, consumer or semi-professional (digital camera, data processing tools, smartphones or tablets), and is not necessarily a high-resolution image.

In a step S41, the hair 401 and the face 402 without the hair are cropped from the image 400. The hair 401 can be extracted using known means, for example those described in the patent application EP2124185 cited previously.

In a step S42, the first database 101 is searched for the hairstyle closest to the photographed one, both in terms of hairstyle type and in terms of color. This step may comprise processing of the initial image 400 of the hairstyle, by applying a pre-established model associated with an editing tool in order to characterize said hairstyle a first time approximately with a few simple parameters predefined by the system (shapes, principal colors, identified textures). It is then possible to begin automatically extracting, from said first database 101, hairstyles and hair that satisfy the initial simple approximate criteria found previously, by means of automatic comparison of similarity between the features of the hairstyle/hair photographed and those extracted, and then to display a few images that respond to optimization of this comparison on a screen. Manual selection of the hairstyle/hair for which the user perceives the similarity as being the best can then be carried out if necessary.

In step S43, the metadata (zoning masks, textures, colors, shapes, etc.) associated with the image of the hairstyle/hair determined in the preceding step are then extracted from said first database. It is then possible (step S44) to reconstruct a hairstyle from the reference image corresponding to the hairstyle type identified for the person and by applying conversion tables (“LUT”) or pairs (masks/LUT) that are present in said metadata associated with the image of the hairstyle selected from the database. This hairstyle is associated with the face 402 previously recorded for the person in order to form the reconstructed image 410 (step S45).

According to one variant, a piece of equipment and a software application provide the person with the IHM tools that vary a finite number of characterization parameters for the hairstyle/hair of said person, on the basis of his initial reconstructed avatar. This involves an independent module that can supplement the composition/calibration tools that can currently be found on the market, for example. This module can then either be sold as a supplement to these tools (such as Photoshop®), or sold separately to interface with these applications as a linked module (“plug-in”).

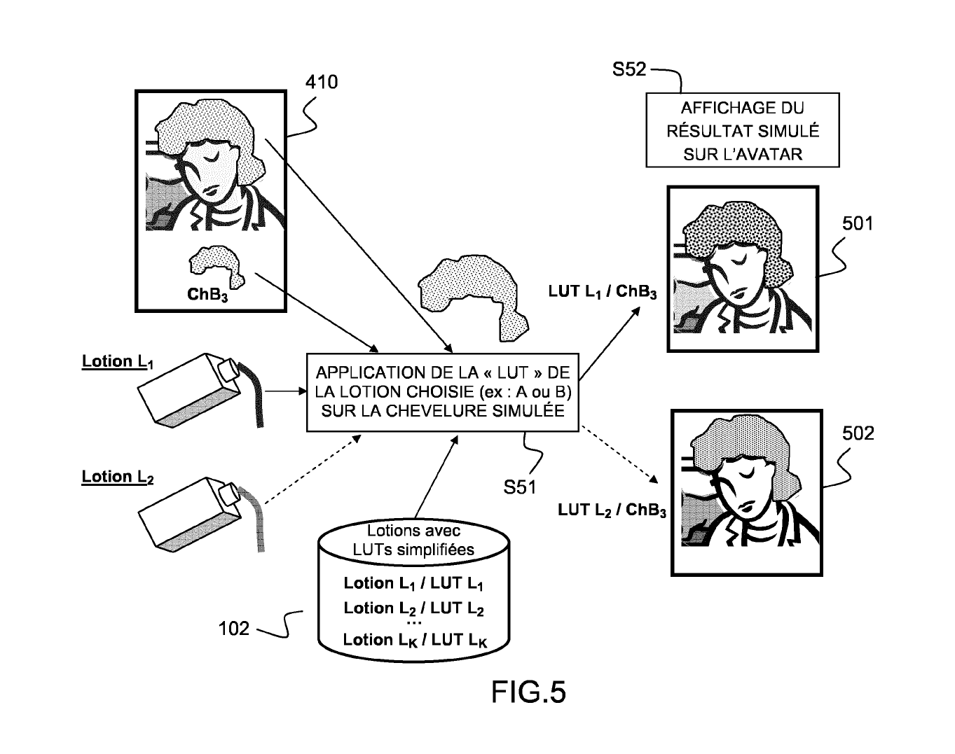

FIG. 5 illustrates a fourth step of the method according to the invention corresponding to the visual simulation of the application of a hair lotion. In a step S51, the colorimetric conversion matrices associated with the various hair lotions previously recorded in the second database 102 are applied in order to simulate the effects of the chosen lotion on the avatar 410 of the person created in the preceding step (FIG. 4). Images 501, 502 obtained following application of the matrices corresponding to one or other of the lotions L₁, L₂ in the example in FIG. 5 can then be displayed (step S52). The applied colorimetric conversion matrix is the one that corresponds to the chosen lotion, which is defined for the hairstyle type/hair type identified for the person. In the case of simplified colorimetric conversion matrices, the matrix can be defined by zone and in each zone, by pixel colorimetric level. It is thus possible, on the basis of the hair/hairstyle in the first database whose parameters are closest to those of the hair/hairstyle of the person, to return the result of the application of a lotion to the avatar of the person in the light environment that served as a reference for the creation of the database of the hairstyles/hair and of the referenced lotions.

According to one variant, it will be possible to simulate the depiction of the hairstyle/hair in various light environments beyond the reference environment of the database, as supplementary elements for assessing the effect of the chosen lotion.

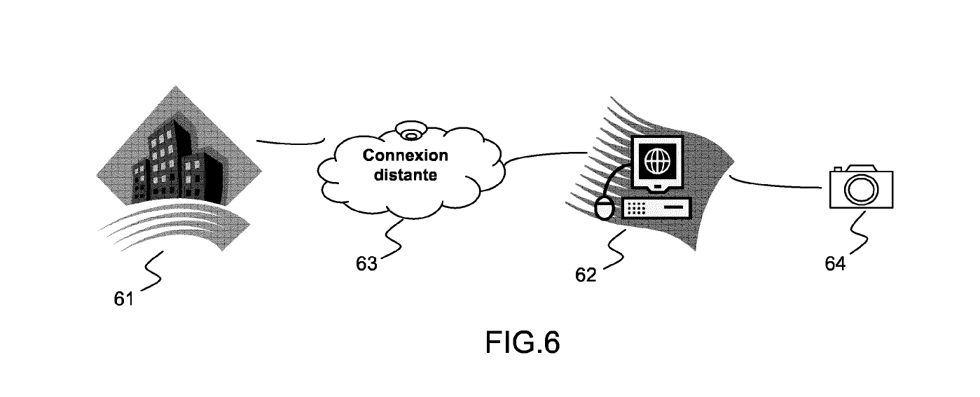

FIG. 6 illustrates a system for implementing the invention according to one exemplary embodiment. The system comprises a server 61 that can be accessed remotely, for example, via the Internet, which contains storage means with the elements of the first and second databases for characterizing the hairstyle type/hair type and hair lotions. By way of example, said databases have been designed previously and can be updated in a central laboratory (not shown). According to one variant, the databases are stored separately but are linked to one another. The server may moreover comprise software for download for implementing the method for simulating hair using variable colorimetry at the point of sale, as described previously. Furthermore, it comprises, specifically at the point of sale, a device 64 for acquiring digital images and a calculation unit 62 for implementing, strictly speaking, the simulation of the hair of the person. The calculation unit 62 may comprise a device for downloading created or modified elements from the centralized laboratory to the accessible server. Finally, the calculation unit may comprise equipment and software and data that can possibly be downloaded to the point of sale of the hair lotions.

Although described using a certain number of detailed exemplary embodiments, the method according to the invention comprises various variants, modifications and improvements that will be obvious to a person skilled in the art, on the understanding that these various variants, modifications and improvements are part of the scope of the invention, as defined by the claims that follow.

1. A method for simulating hair using variable colorimetry comprising:
prior recording, in a first database, of a given number of hairstyle images in given types, and, for each hairstyle image in a given type, of at least one associated calorimetric conversion matrix allowing said hairstyle image to be obtained by applying said matrix to a reference hairstyle image in the same type;
prior recording, in a second database, for a given number of hair lotions, of at least one colorimetric conversion matrix per lotion;
determining, by image recognition on the basis of an image of a hairstyle extracted from an initial digital image of a person, of a lifelike hairstyle image in the first database,
identifying, in the first database, of a reference hairstyle image in the same type as that of the lifelike hairstyle image and of a colorimetric conversion matrix associated with the lifelike hairstyle image,
creating, on the basis of the initial digital image of the person, of an avatar superimposing, on the image of the face of the person previously extracted from said initial image, a hairstyle image reconstructed by applying to a reference hairstyle image from said first database a colorimetric conversion matrix associated with the lifelike hairstyle image;
applying, to said reconstructed hairstyle image, of a colorimetric conversion matrix from said second database corresponding to the hair lotion chosen in order to simulate the expected color.

2. The method for simulating hair using variable colorimetry as claimed in claim 1, wherein, each hairstyle exhibiting a hairstyle type and a given hair type, the colorimetric conversion matrix associated with a hairstyle image allows the conversion of the colorimetric value of each pixel of said hairstyle image in relation to the colorimetric value of the corresponding pixel of a reference hairstyle image in the same hairstyle type.

3. The method for simulating hair using variable colorimetry as claimed in claim 1, wherein the reconstructed hairstyle image is obtained by applying the conversion matrix associated with the lifelike hairstyle image to a reference hairstyle image from said database in the same type as said lifelike hairstyle image.

4. The method for simulating hair using variable colorimetry as claimed in claim 1, wherein the reconstructed hairstyle image is obtained by applying the conversion matrix associated with the lifelike hairstyle image to a reference hairstyle image from said database in a different type than that of said lifelike hairstyle image.

5. The method for simulating hair using variable colorimetry as claimed in claim 1, further comprising:
for a given reference hairstyle, prior recording, in said first database, of a given number of reference hairstyle images according to various shot parameters and recording of one or more conversion matrices, each linked to one of said parameters, allowing conversion of the colorimetric values of each of the pixels of a reference image associated with said parameter on the basis of those of each of the pixels of a reference image defined as principal reference image.

6. The method for simulating hair using variable colorimetry as claimed in claim 1, further comprising:
at the time of the prior recording of said first database and/or of said second database, a step of simplification of the colorimetric conversion matrices comprising the definition of colorimetric conversion matrices by zones of the image.

7. The method for simulating hair using variable colorimetry as claimed in claim 1, further comprising:
at the time of the prior recording of said second database, a step of reduction of the number of colorimetric conversion matrices associated with a given hair lotion.

8. The method for simulating hair using variable colorimetry as claimed in claim 1, wherein said colorimetric conversion matrices of said hairstyle images each form part of a set of metadata associated with each of said hairstyle images.

9. The method for simulating hair using variable colorimetry as claimed in claim 7, wherein said metadata further comprise attributes of the hairstyle image, including shot parameters.

10. A device for simulating hair using variable colorimetry comprising:
storage means comprising:
a first database with a given number of hairstyle images in given types, and, for each hairstyle image in a given type, at least one associated colorimetric conversion matrix allowing said hairstyle image to be obtained by applying said matrix to a reference hairstyle image in the same type;
a second database with, for a given number of hair lotions, at least one colorimetric conversion matrix per lotion;
means for acquiring an initial digital image of a person;
a calculation unit allowing:
determining, by image recognition on the basis of an image of a hairstyle extracted from an initial digital image of the person, of a lifelike hairstyle image in the first database,
identifying, in the first database, of a reference hairstyle image in the same type as that of the lifelike hairstyle image and of a colorimetric conversion matrix associated with the lifelike hairstyle image,
creating of an avatar for said person, superimposing, on the image of the face of the person previously extracted from said initial image,
a hairstyle image reconstructed by applying to a reference hairstyle image from said first database a colorimetric conversion matrix associated with the lifelike hairstyle image, and
transforming of said reconstructed image by applying a colorimetric conversion matrix from said second database corresponding to the hair lotion chosen for simulating the expected color.

11. The device for simulating hair using variable colorimetry as claimed in claim 10, wherein said storage is arranged in a server 1614 situated at a distance from the calculation unit, and moreover comprising a remote connection between said server and the calculation unit.

12. A computer program product comprising program code instructions recorded on a medium that can be read by a computer, for the execution of the steps of the process of the method for simulating hair using variable colorimetry as claimed in claim 1 when said program is executed on a computer.

13. The method for simulating hair using variable colorimetry as claimed in claim 2, wherein the reconstructed hairstyle image is obtained by applying the conversion matrix associated with the lifelike hairstyle image to a reference hairstyle image from said database in the same type as said lifelike hairstyle image.

14. The method for simulating hair using variable colorimetry as claimed in claim 2, wherein the reconstructed hairstyle image is obtained by applying the conversion matrix associated with the lifelike hairstyle image to a reference hairstyle image from said database in a different type than that of said lifelike hairstyle image.

15. The method for simulating hair using variable colorimetry as claimed in claim 2, further comprising:
for a given reference hairstyle, prior recording, in said first database, of a given number of reference hairstyle images according to various shot parameters and recording of one or more conversion matrices, each linked to one of said parameters, allowing conversion of the colorimetric values of each of the pixels of a reference image associated with said parameter on the basis of those of each of the pixels of a reference image defined as principal reference image.

16. The method for simulating hair using variable colorimetry as claimed in claim 2, further comprising:
at the time of the prior recording of said first database and/or of said second database, a step of simplification of the colorimetric conversion matrices comprising the definition of colorimetric conversion matrices by zones of the image.

17. The method for simulating hair using variable colorimetry as claimed in claim 2, further comprising:
at the time of the prior recording of said second database, a step of reduction of the number of colorimetric conversion matrices associated with a given hair lotion.

18. The method for simulating hair using variable colorimetry as claimed in claim 2, wherein said colorimetric conversion matrices of said hairstyle images each form part of a set of metadata associated with each of said hairstyle images.

19. The method for simulating hair using variable colorimetry as claimed in claim 17, wherein said metadata further comprise attributes of the hairstyle image, including shot parameters.

20. The method for simulating hair using variable colorimetry as claimed in claim 2, further comprising:
for a given reference hairstyle, prior recording, in said first database, of a given number of reference hairstyle images according to various shot parameters and recording of one or more conversion matrices, each linked to one of said parameters, allowing conversion of the colorimetric values of each of the pixels of a reference image associated with said parameter on the basis of those of each of the pixels of a reference image defined as principal reference image;
at the time of the prior recording of said first database and/or of said second database, a step of simplification of the colorimetric conversion matrices comprising the definition of colorimetric conversion matrices by zones of the image; and
at the time of the prior recording of said second database, a step of reduction of the number of colorimetric conversion matrices associated with a given hair lotion;
wherein the reconstructed hairstyle image is obtained by applying the conversion matrix associated with the lifelike hairstyle image to a reference hairstyle image from said database in the same type as said lifelike hairstyle image or in a different type than that of said lifelike hairstyle image;
wherein said colorimetric conversion matrices of said hairstyle images each form part of a set of metadata associated with each of said hairstyle images; and
wherein said metadata further comprise attributes of the hairstyle image, including shot parameters.
